(19) United States
(12) Patent Application Publication
(10) Pub. No.: US 2020/0097666 A1
(43) Pub. Date: Mar. 26, 2020

(54) CONTENT MODIFICATION USING DEVICE-MOBILE GEO-FENCES

(71) Applicant: International Business Machines Corporation, Armonk, NY (US)

(72) Inventors: KOMMINIST WELDEMARIAM, NAIROBI (KE); DAVID MOININA SENGEH, NAIROBI (KE); ASHLEY DANIEL GRITZMAN, SANDTON JOHANNESBURG GAUTENT (ZA); SHIKHAR KWATRA, MORRISVILLE, NC (US)

(21) Appl. No.: 16/139,063

(22) Filed: Sep. 23, 2018

(51) Int. Cl. G06F 21/60; H04L 29/06; G06F 21/62; G06N 3/08

(52) U.S. Cl. CPC G06F 21/604; G06N 3/08; G06F 21/6218; H04L 63/107

(57) ABSTRACT

A computer-implemented method includes determining that content is objectionable to an individual or to a cohort of individuals; establishing, at a device, a geo-fenced area around the device, wherein the geo-fenced area is selective of the individual or the cohort of individuals; detecting and identifying a person entering the geo-fenced area; determining that the person entering the geo-fenced area corresponds to the individual or cohort of individuals to whom the content is objectionable; and responsive to determining that the person entering the geo-fenced area corresponds to the individual or cohort of individuals to whom the content is objectionable, triggering an ameliorating action with respect to display of the objectionable content on the device. The method can be implemented by the device or by a cloud (networked system) of computing devices, according to instructions embodied in a computer readable medium.

### BACKGROUND

The present invention relates to electrical, electronic, and computer arts, and more specifically, to filtering or modifying electronic content.

Televisions, cellular phones, and other electronic devices frequently are used to present auditory or audiovisual electronic media content. Some such content may be objectionable to certain individuals, and some of those potentially offended or affected (e.g., emotionally) individuals can be identified as members of particularly sensitive or protected cohorts. Efforts are made to restrict presentation of potentially objectionable content to members of sensitive or protected cohorts, for example, requiring entry of personal identification numbers (PINs) or other passcodes in order to present such content. Once a PIN or passcode has been entered, the content is presented without interruption unless a viewer manually intervenes to pause the presentation.

### SUMMARY

Principles of the invention provide techniques for content modification using device-mobile geo-fences. In one aspect, an exemplary method includes determining that content is objectionable to an individual or to a cohort of individuals; establishing, at a device, a geo-fenced area around the device, wherein the geo-fenced area is selective of the individual or the cohort of individuals; detecting and identifying a person entering the geo-fenced area; determining that the person entering the geo-fenced area corresponds to the individual or cohort of individuals to whom the content is objectionable; and responsive to determining that the person entering the geo-fenced area corresponds to the individual or cohort of individuals to whom the content is objectionable, triggering an ameliorating action with respect to display of the objectionable content on the device.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

In view of the foregoing, techniques of the present invention can provide substantial beneficial technical effects. For example, one or more embodiments provide one or more of:

A geo-fenced area that moves with a mobile device.

Content control that is responsive to individuals entering a geo-fenced area that surrounds a device.

Content control that is responsive to individuals entering a geo-fenced area that moves with a mobile device.

Content control that automatically responds to individuals entering a geo-fenced area.

A user-selective geo-fence surrounding a device.

A user-selective geo-fence that moves with a mobile device.

Content-driven geo-fence surrounding a device.

Content-driven geo-fence that moves with a mobile device.

A geo-fenced area that moves with predicted characteristics of content.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 depicts a method that is implemented by a content modification module, according to an exemplary embodiment;

FIG. 4 depicts a workflow among components of the content modification module;

FIG. 5 depicts a computer system that may be useful in implementing one or more aspects and/or elements of the invention, also representative of a cloud computing node according to an embodiment of the present invention

FIG. 6 shows non-limiting exemplary aspect of geofence implementation.

### DETAILED DESCRIPTION

As increasing quantities of electronic content are available or pushed to end users in various forms and by various channels (e.g., via television, social media, streaming media) which are integral parts of our day-to-day lives, negative impacts or risks of content with respect to certain users or cohorts of users are widely noticed. Accordingly, one aspect of the invention is to intelligently control content items on computing and/or communication devices based on analyzing the content and characteristics of an incoming user or cohort of incoming users, thus minimizing, reducing or eliminating possible damages or risks that can be caused by the content item(s) inappropriateness. Another aspect of the invention is to implement such content controls based on a dynamic, device-mobile geo-fence. Another aspect of the invention is to implement such content controls based on a user-selective geo-fence.

Generally, a geo-fence has been considered as a virtual perimeter for a real-world geographic area. A geo-fence can be dynamically generated, as in a radius around a fixed point location, or a geo-fence can be a predefined set of boundaries (such as school zones or neighborhood boundaries). Interactions with a conventional geo-fence, to control the operation of mobile devices that enter or leave the fenced area, are governed by global positioning system (GPS) locations of the mobile devices. Geo-fences have been widely discussed for location-based services applied to telemetry, device management, security, safety, and device-user interaction, to mention some examples.

By contrast, one or more embodiments provide a geo-fence around a mobile device, i.e. a device-mobile geo-fence. Interactions with the device-mobile geo-fence, to control the operation of the mobile device based on individuals entering or leaving the fenced area, are governed by onboard sensors of the mobile device, e.g., a camera or a microphone.

Additionally, one or more embodiments provide a user-selective geo-fence, i.e. a geo-fence that operates for some users or cohorts of users and not for others. A device implementing the user-selective geo-fence identifies potential viewers individually, or as members of a cohort, based on data provided by onboard sensors of the device, e.g., a camera or a microphone.

It will be appreciated that although certain embodiments are implemented entirely in a device for the sake of speed in operation, other embodiments are implemented in a cloud configuration wherein certain features or modules (e.g., face recognition, voice recognition) are facilitated by a server remote from the mobile device for which the user-selective geo-fence is established.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

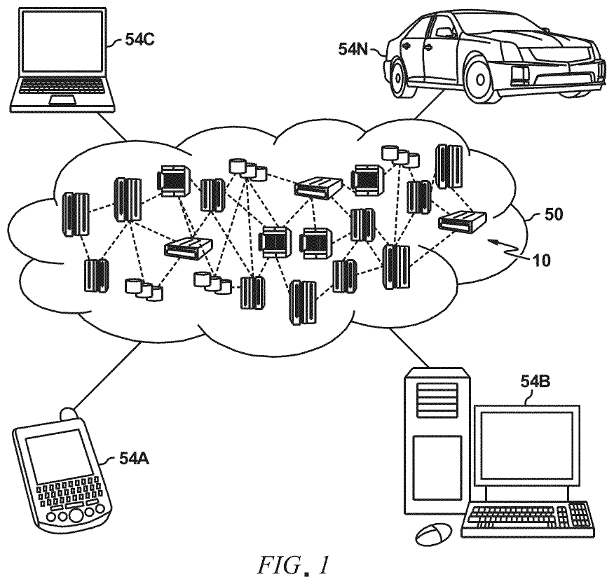

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

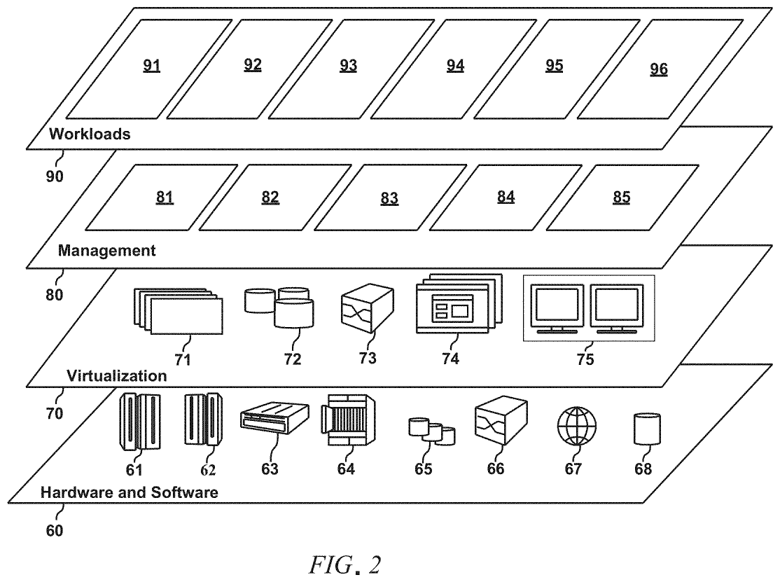

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a content modification module 96.

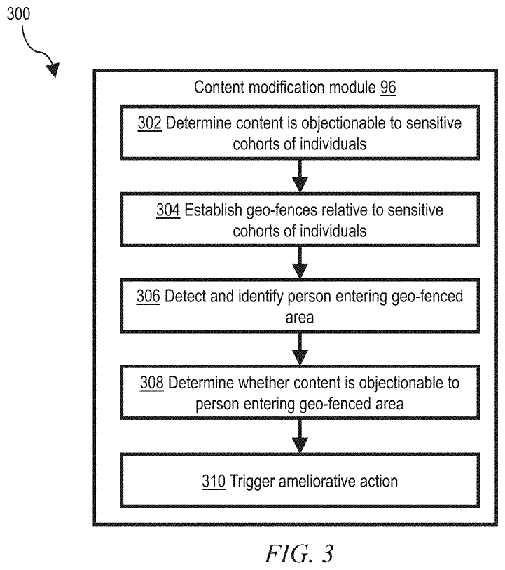

FIG. 3 depicts a method 300 for dynamic geo-fencing that is implemented by the content modification module 96. According to the method 300, the content modification module 96 effectively controls or configures content items (e.g., multimedia, voice, image, graphics) based on content item characteristics (i.e., desirability or appropriateness) in relation to a potential viewer entering a geo-fenced area surrounding a device displaying the content. In other words, the content modification module 96 dynamically generates one or more geo-fences surrounding a mobile device in relation to content items that are displayed, or predicted to be displayed, on the mobile device. Exemplary geo-fences include an audio radius from a mobile device, a line-of-sight distance from a mobile device, a doorway (detected by computer vision software) of a room containing a mobile device, etc. In one or more embodiments, the content modification module 96 establishes the geo-fence in response to inputs from multiple devices, e.g., a primary device on which content is displayed as well as secondary devices such as Internet-of-Things devices like security cameras, voice-responsive smart speakers, etc.

In one or more embodiments, the content modification module 96 further highlights contours of the dynamically created geo-fence zones at an interactive graphical user interface (GUI) of the mobile device or another device connected in communication with the mobile device, and enables user input via the interactive GUI to manually configure the contours of the geo-fenced zones. One example of user interface that could be employed in some cases is hypertext markup language (HTML) code served out by a server or the like, to a browser of a computing device of a user. The HTML is parsed by the browser on the user's computing device to create a GUI.

One or more embodiments provide a machine learning mechanism for generation of multiple zones of geo-fence for specific duration time T. The next step involves triggering the generation of multiple zones of geo-fences (minors within x radius, adults with y radius, etc.) dynamically for a duration of time T where T is the expected duration of the inappropriate content on-the air or on the display. Once the initial dynamic GUI is configured, it is trained via the machine learning-based recurrent convolutional neural network or alternate multi-level classifier with two output parameters to remember the primary user's inputs and the boundary parameters with respect to each cluster of secondary user profiles. The users in this case are two different groups of people. The primary user owns the mobile device and can see dynamic geo-fences displayed on their device based on learning the primary user's inputs. At the same time, the primary user can set boundary parameters with respect to each cluster of individuals (secondary users) who may enter the geo-fenced zone. Thus, the secondary users are the respective individuals or groups of people who are in the vicinity of the respective zones whose profiles are also stored in the respective cloud database.

In a method of training machine learning models for automatically generating geo-fences, according to one or more embodiments, user profiles comprise respective categories based on attributes of the individuals in each category, in order to understand what content would be inappropriate for them. For example, three parameters with respect to the user's profile include:

1. Confined area of an environment containing coordinates of the user's mobile device(s) where content is being displayed or played.

2. Geo-spatial metrics of the respective users confined in the space (gait or sound analysis to determine the proximity of plurality of users with respect to the display device).

3. Content analysis (including multimedia content such as audio or video) engine monitoring the content—with re-configurable weights to be fed in the classifier.

Based on results of the gait or sound analysis, the system detects and determines the identity of each user in the vicinity. The system then dynamically matches each identified identity of a user with their corresponding user profile to establish a boundary for the geo-fence. In another scenario, if the geo-fence boundary is already established (e.g., pre-determined), the system detects the presence of individuals already inside the geo-fence and establishes the users identities. For each established user identity, the system then pulls their corresponding profiles so as to automatically control content to be displayed on the content display (e.g., TV).

In one or more embodiments, the content analysis determines one or more characteristics of the content pertaining to content desirability (i.e., content objectionability) in accordance with one or more users. The determined content desirability information will be used to configure one or more geo-fence boundaries.

The desired outputs of the machine learning model are dynamic geo-fence boundaries in a region surrounding a mobile device (Output 1), and a duration of time (Output 2) during which a responsive ameliorating action should be taken as further discussed below. For example, if a device displays content that includes provocative, offensive, traumatizing, or otherwise potentially objectionable scenes, then at 302 the content modification module 96 determines the content is potentially objectionable and at 304 establishes one or more geo-fences relative to individuals who belong to cohorts potentially sensitive to the scenes. Boundaries of the geo-fences are based on distances at which the content would be audible or visible to the individuals.

Then, in one or more embodiments, in response to a person (potential viewer or listener) entering the geo-fenced area, at 306 the content modification module 96 identifies the potential viewer individually or by cohort; at 308 determines whether the content is suitable for the potential viewer based on the viewer's individual identity or cohort (e.g., determines whether the potential viewer is a member of a sensitive cohort, to whom the content is objectionable); and at 310 facilitates an ameliorative action in case the content is not suitable. For example, at 310 the content modification module 96 modifies or conceals the content in response to a determination that the content is not suitable. As one specific example, a runner may be carrying a mobile device that is playing a “run playlist” including music with lyrics that are offensive to members of a given cohort. According to an exemplary embodiment, at 304 the content modification module 96 establishes a geo-fence around the mobile device while the “run playlist” is active. As the runner approaches a person who is a member of the given cohort, at 306 the content modification module 96 detects the person entering the geo-fenced area that surrounds the mobile device and at 310 the content modification module 96 mutes the music.

In another embodiment, a method is provided of receiving a signal by one or more devices that are currently displaying or playing (or are about to display or play) a content item. The primary user's device, which controls the geo-fence area, sends a signal to the one or more devices when a person or group enters the geo-fence area. In one or more embodiments, the signal includes additional contextual information detected by the system. The detected additional contextual information may include the mood, temporary nature of an individual's cognitive state, etc. of the user that can be inferred from the user mobile device, sensors, and user historical usage data. Alternatively, the incoming user can explicitly supply their additional contextual information. The content modification module 96 analyzes the received signal (and contextual information), then triggers an amelioration action based on the desirability or objectionable nature of the content item and based on the analysis of the contextual information that may offend or affect the incoming user or group of users.

In one or more embodiments, at 306 the content modification module 96 detects and identifies a person by using a camera in combination with face recognition or body recognition software (e.g., if the person is short, or has soft facial features, the device identifies the person as a member of a potentially sensitive cohort). In one or more embodiments, the device detects and identifies the person by using a microphone in combination with voice/sound analysis software (e.g., if the person has a high-pitched voice, or soft footsteps, the device identifies the person as a member of a potentially sensitive cohort). Various other methods for detecting a person entering one or more generated geo-fenced zones or regions include:

Gait analysis that may use sound/cadence or computer vision.

Onboard communication sensors (e.g., wireless network search signal from incoming user mobile device, smart-watch, or smart-eye lenses).

Sound analysis to know who is speaking in a room and where he or she is with reference to a display.

Facial recognition, image recognition, or biometrics equipment that is installed at a physical access control barrier. The facial recognition coupled with other data (e.g., analysis of the history of usage data to determine a distinct information about the incoming user) is used to establish the identity of the user.

Analysis of accelerometer data based on different individuals handling a mobile device differently. The accelerometer and other sensory data will be used to estimate the proximity of the user in relation to the geo-fenced area.

Analysis of history data such as a pattern of shifting focus from a computer game to an internet browser, or from a cartoon TV show to breaking news.

One or more embodiments differ from conventional filtering software in that the analysis of the history of usage is used to establish the geo-fence area.

The content modification module 96 determines suitability of content for a given user or cohort of users, at 302 based on characteristics of the content (e.g., controversial or provocative nature) and based on characteristics of the user or cohort of users. The content modification module 96, at 308, determines suitability of content for a given individual entering the geo-fenced area based on characteristics of the content and based on characteristics of the individual (e.g., temporary nature of an individual's cognitive state). As discussed above, the characteristics of the individual (e.g., cognitive state) can be inferred from the user mobile device, sensors, and user historical usage data. Alternatively, the individuals can explicitly supply their cognitive state as part of the additional contextual information. In one or more embodiments, the content modification module 96 invokes or interfaces with a cognitive computing system that understands classification rules and supports the task of identifying concepts that may be considered appropriate for a given cohort. For example, certain content of controversial or provocative nature is rated as inappropriate for protected audiences in many countries, while content of less controversial or provocative nature is rated as appropriate for these audiences. In one or more embodiments, a cognitive computing system, which is accessed by the content modification module 96 at 302 and at 308, provides automatic content classification ratings, over different types of media (such as, video, audio, text, images). As one example, a video stream may be correlated with an accompanying audio stream and text to enhance the accuracy of automated content classification ratings. In one or more embodiments, the cognitive computing system accessed by the content modification module 96 analyzes pre-compiled data pertaining to desirability or inappropriateness of certain content organized per individual or cohort. The cognitive computing system implements custom design machine learning models or algorithms to predict or estimate “desirability” or “inappropriateness” of an incoming content or portion of content item. In one or more embodiments, such a cognitive computing system is trained by analyzing data from data sources such as pre-compiled profiles and reviews of content. The cognitive computing system then estimates “desirability” or “inappropriateness” of an incoming content or portion of content in real time according to various specifications and restrictions that will be apparent to the ordinary skilled worker.

Generally, a neural network includes a plurality of computer processors that are configured to work together to implement one or more machine learning algorithms. The implementation may be synchronous or asynchronous. In a neural network, the processors simulate thousands or millions of neurons, which are connected by axons and synapses. Each connection is enforcing, inhibitory, or neutral in its effect on the activation state of connected neural units. Each individual neural unit has a summation function which combines the values of all its inputs together. In some implementations, there is a threshold function or limiting function on at least some connections and/or on at least some neural units, such that the signal must surpass the limit before propagating to other neurons. A cognitive neural network can implement supervised, unsupervised, or semi-supervised machine learning.

In one or more embodiments the geo-fences are defined at 304 by, among other things, analyzing data from an electronic calendar (e.g., when family members will arrive at home or who from among the family members will arrive at home, when co-workers will arrive at a meeting, and the like) to define times for activating/deactivating particular geo-fences, and/or by analyzing personal profiles (including, e.g., medical history and behavioral history, extracts from social media, previous engagement history, and the like). The previous engagement history is derived from (or related to) the historical interactions and reactions of a user in response to objectionable or desirable content. Note that in one or more embodiments, from the analysis of the profiles, the system derives geo-fence zone requirements and properties.

Thus, when at 306 the content modification module 96 detects a person entering the geo-fenced area and identifies the person as a member of a potentially sensitive cohort, then at 310 the content modification module 96 facilitates an ameliorative action, e.g., minimizes a viewing window, mutes sound, pauses display, imposes a distorting filter on the display, changes channels, turns off content entirely, alters or morphs or trims content item or part of content item, changes screen brightness, fast-forwards or skips over segments of content, blurs image or video or audio, transfers content to a most probable secondary device, blocks access to certain websites or apps, locks the mobile device, sounds an alarm, or the like. It is worth noting that the skilled artisan, to implement one or more embodiments, will be able to adapt known mechanisms employed for blocking access, based on the teachings herein; however, the causation of the blocking or controlling is carried out using one or more inventive techniques disclosed herein.

For example, when at 306 a person enters a geo-fenced area surrounding the mobile device, then at 310 the content modification module 96 causes the mobile device to emit a sound that alerts a user of the device to act on the device or displayed content.

As another example, the content modification module 96 alters displayed or played content items (including predicted-to-be-displayed or -played content items) so that the content items can be screened or suppressed in response to a person entering a geo-fenced area. In another aspect, the content modification module 96 generates an alert (e.g., a signal, a sound) when the content item is to be screened or suppressed. As another example, the content modification module 96 transfers the content items to the most probable secondary device in response to a person entering a geo-fenced area.

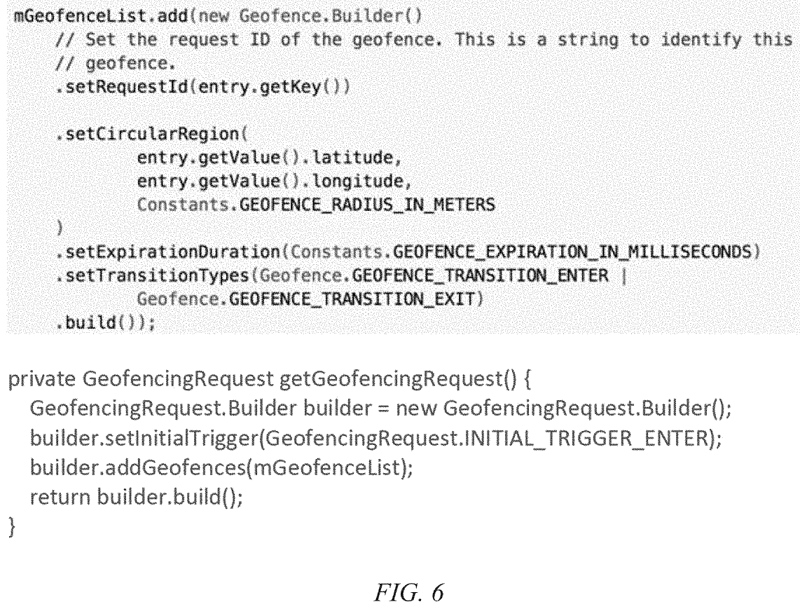

By way of a non-limiting implementation example, referring to FIG. 6, enablement for initiating geo-fence objects may use Geofence.Builder to create one or more geo-fence zones, setting the desired radius, duration, and transition types for the geo-fence. FIG. 6 shows a non-limiting example of how to populate a list object named mGeofenceList. By way of a continued non-limiting example, for specifying geo-fences and initializing the triggers to be fed to the learning system, the snippet in FIG. 6 beginning at “private GeofencingRequest getGeofencingRequest( ) {” uses the GeofencingRequest class and its nested GeofencingRequestBuilder class to specify the geofences to monitor and to set how related geofence events are triggered.

Given the discussion thus far, it will be appreciated that, in general terms, an exemplary method, according to an aspect of the invention, includes determining that content is objectionable to an individual or to a cohort of individuals; establishing, at a device, a geo-fenced area around the device, wherein the geo-fenced area is selective of the individual or the cohort of individuals; detecting and identifying a person entering the geo-fenced area; determining that the person entering the geo-fenced area corresponds to the individual or cohort of individuals to whom the content is objectionable; and responsive to determining that the person entering the geo-fenced area corresponds to the individual or cohort of individuals to whom the content is objectionable, triggering an ameliorating action with respect to display of the objectionable content on the device.

In one or more embodiments, determining the content is objectionable includes applying a custom machine learning module to the content and to characteristics of the individual or the cohort of individuals. In one or more embodiments, the custom machine learning module is implemented by a cognitive neural network.

In one or more embodiments, the device is a mobile device.

In one or more embodiments, the geo-fenced area is established as an audio radius around the device,

In one or more embodiments, detecting and identifying the person entering the geo-fenced area is accomplished using a camera of the device in combination with face recognition software. On the other hand, in one or more embodiments, detecting and identifying the person entering the geo-fenced area is accomplished by establishing a network connection with an external camera and using the external camera to observe the person.

In one or more embodiments, detecting and identifying the person entering the geo-fenced area is accomplished using a microphone of the device in combination with gait analysis software. On the other hand, in one or more embodiments, detecting and identifying the person entering the geo-fenced area is accomplished by establishing a network connection with an external microphone and using the external microphone to listen to the person.

In one or more embodiments, the ameliorating action includes transferring the objectionable content from the device to a secondary device.

In one or more embodiments, the ameliorating action includes delaying display of the objectionable content at the device. Further, it will be appreciated by the ordinary skilled worker that various embodiments provide certain advantages by comparison to common techniques for web filtering or geo-fencing.

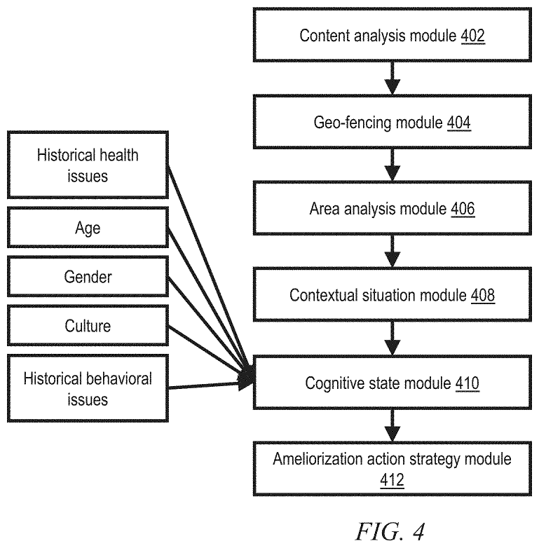

For example, referring to FIG. 4, one or more embodiments include (i) a content analysis module 402 which determines the degree of content items “desirability” or “inappropriateness” in relation to an incoming user or a group of incoming users; (ii) a geo-fencing module 404 which dynamically generates one or more virtual geo-fence zones or regions (e.g., sensitive users within audio radius x, adults with audio radius y, line-of-sight distance z, etc.); (iii) an area analysis module 406 which detects an incoming user or group of users within the generated one or more geo-fenced zones or regions; (iv) a contextual situation module 408 which receives and analyzes at least one signal along with additional contextual information from the one or more geo-fence zones corresponding to a user or group of users are approaching to the one or more geo-fence zones; (v) a cognitive state module 410 which estimates the cognitive state of an individual entering the geo-fence zone, based on factors including their historical health issues, their age, gender, culture, and historical behavioral issues; and (vi) an ameliorization action strategy module 412 for which controls the content items on user computing or communicating devices using one or more amelioration actions based on the interpretation of the received signal. The content analysis module 402 implements step 302 of method 300. The geo-fencing module 404 implements step 304 of method 300. The area analysis module 406 implements step 306 of method 300. The contextual situation module 408 and the cognitive state module 410 implement step 308 of method 300. The ameliorization action strategy module 412 implements step 310 of method 300.

As another example, one or more embodiments provide for controlling content items using dynamically created geo-fence zones based on analysis of the content and corresponding desirability or inappropriateness. Certain embodiments define different ways of amelioration modulation pertaining to the proximity of the user or plurality of users: changing channels; turning off content entirely; altering or morphing or trimming a content item or part of a content item by, e.g., changing screen brightness, changing sound output volumes including de-amplifying at undesirable segments, muting at inappropriate segments, fast-forwarding/skipping or deleting certain segments, blurring image or video; transferring the content items to a user's most probable secondary device; blocking access to certain websites or apps; locking the computing device such that a password is needed to unlock, e.g., by a pop up dialogue box that contains a question that a primary user is likely to know the answer, but a member of a sensitive cohort is not likely to know; or sounding an alarm, for example, the computing device may emit a certain sound to alert a primary user that a member of a sensitive cohort is viewing restricted content, etc.

As yet other examples, one or more embodiments implement various methods for detecting of an incoming user or group of users within one or more generated geo-fenced zones or regions. These methods may include: (i) custom gait analysis technique, based on configuring a sensitive user or cohort of sensitive users in the system, which may use sound/cadence, computer vision (e.g., who is walking), on-board sensors (e.g., from incoming user mobile device, smart-watch, smart-eye lenses, etc.) or other sensors (Kinect® device (registered mark of Microsoft Corporation, Redmond, Wash., USA) or other cameras); (ii) using sound analysis to know who is speaking in the room and how far away she or he is from the screen; (iii) using facial recognition or image recognition that is installed at a gate entrance of a geo-fence; (iv) using biometrics if an access area is enabled with a biometric lock; (v) using accelerometers—different users may handle a mobile phone differently; (vi) using device usage history data, e.g., a user may be playing an E-rated computer game, and then switch over to the internet browser. Similarly, a user may be watching a TV-7 rated cartoon, and then change channel, etc. In one or more embodiments, items (iii)-(vi) provide data points that can be used to determine the identity of the incoming user and pull their corresponding profiles so that appropriate amelioration actions will be taken when objectionable content item(s) are screened.

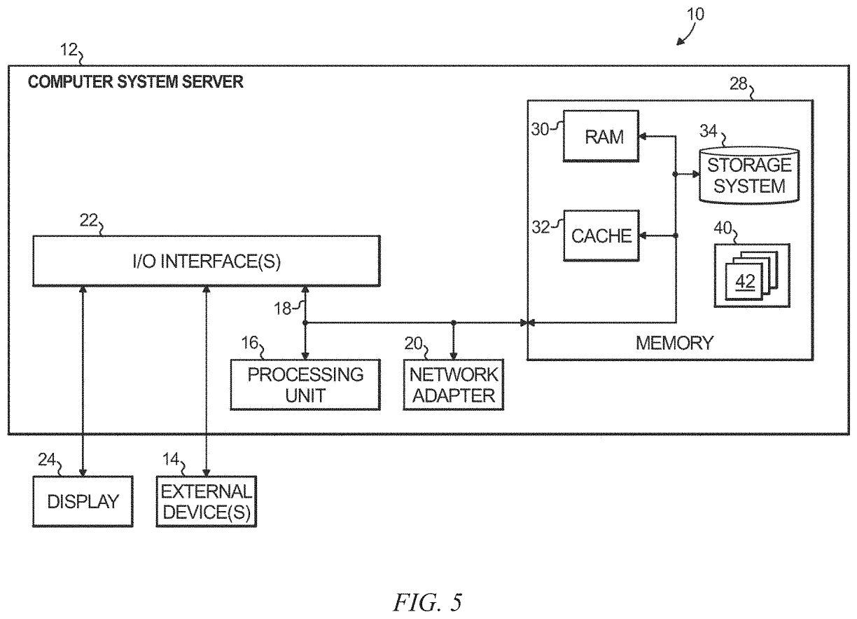

One or more embodiments of the invention, or elements thereof, can be implemented in the form of an apparatus including a memory and at least one processor that is coupled to the memory and operative to perform exemplary method steps, or in the form of a non-transitory computer readable medium embodying computer executable instructions which when executed by a computer cause the computer to perform exemplary method steps. FIG. 5 depicts a computer system that may be useful in implementing one or more aspects and/or elements of the invention, also representative of a cloud computing node according to an embodiment of the present invention. Referring now to FIG. 5, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 5, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 5) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining that content is objectionable to an individual or to a cohort of individuals;
establishing, at a device, a geo-fenced area around the device, wherein the geo-fenced area is selective of the individual or the cohort of individuals;
detecting and identifying a person entering the geo-fenced area;
determining that the person entering the geo-fenced area corresponds to the individual or cohort of individuals to whom the content is objectionable; and
responsive to determining that the person entering the geo-fenced area corresponds to the individual or cohort of individuals to whom the content is objectionable, triggering an ameliorating action with respect to display of the objectionable content on the device.

2. The method of claim 1 wherein determining the content is objectionable includes applying a custom machine learning module to the content and to characteristics of the individual or the cohort of individuals.

3. The method of claim 2 wherein the custom machine learning module is implemented by a cognitive neural network.

4. The method of claim 1 wherein the device is a mobile device.

5. The method of claim 1 wherein the geo-fenced area is established as an audio radius around the device,

6. The method of claim 1 wherein detecting and identifying the person entering the geo-fenced area is accomplished using a camera of the device in combination with face recognition software.

7. The method of claim 1 wherein detecting and identifying the person entering the geo-fenced area is accomplished by establishing a network connection with an external camera and using the external camera to observe the person.

8. The method of claim 1 wherein detecting and identifying the person entering the geo-fenced area is accomplished using a microphone of the device in combination with gait analysis software.

9. The method of claim 1 wherein detecting and identifying the person entering the geo-fenced area is accomplished by establishing a network connection with an external microphone and using the external microphone to listen to the person.

10. The method of claim 1 wherein the ameliorating action includes transferring the objectionable content from the device to a secondary device.

11. The method of claim 1 wherein the ameliorating action includes delaying display of the objectionable content at the device.

12. A non-transitory computer readable medium embodying computer executable instructions which when executed by a computer cause the computer to facilitate the method of:
determining that content is objectionable to an individual or to a cohort of individuals;
establishing, at a device, a geo-fenced area around the device, wherein the geo-fenced area is selective of the individual or the cohort of individuals;
detecting and identifying a person entering the geo-fenced area;
determining that the person entering the geo-fenced area corresponds to the individual or cohort of individuals to whom the content is objectionable; and
responsive to determining that the person entering the geo-fenced area corresponds to the individual or cohort of individuals to whom the content is objectionable, triggering an ameliorating action with respect to display of the objectionable content on the device.

13. The medium of claim 12 wherein determining the content is objectionable includes applying a custom machine learning module to the content and to characteristics of the individual or the cohort of individuals.

14. The medium of claim 12 wherein the geo-fenced area is established as an audio radius around the device,

15. The medium of claim 12 wherein detecting and identifying the person entering the geo-fenced area is accomplished using a camera of the device in combination with face recognition software.

16. The medium of claim 12 wherein detecting and identifying the person entering the geo-fenced area is accomplished using a microphone of the device in combination with gait analysis software.

17. The medium of claim 12 wherein the ameliorating action includes transferring the objectionable content from the device to a secondary device.

18. The medium of claim 12 wherein the ameliorating action includes delaying display of the objectionable content at the device.

19. An apparatus comprising:
a memory embodying computer executable instructions; and
at least one processor, coupled to the memory, and operative by the computer executable instructions to facilitate a method of:
determining that content is objectionable to an individual or to a cohort of individuals;
establishing, at a device, a geo-fenced area around the device, wherein the geo-fenced area is selective of the individual or the cohort of individuals;
detecting and identifying a person entering the geo-fenced area;
determining that the person entering the geo-fenced area corresponds to the individual or cohort of individuals to whom the content is objectionable; and
responsive to determining that the person entering the geo-fenced area corresponds to the individual or cohort of individuals to whom the content is objectionable, triggering an ameliorating action with respect to display of the objectionable content on the device.

20. The apparatus of claim 19 wherein determining the content is objectionable includes applying a custom machine learning module to the content and to characteristics of the individual or the cohort of individuals.
